(19) United States
(12) Patent Application Publication
(10) Pub. No.: US 2018/0236858 A1
(43) Pub. Date: Aug. 23, 2018

(54) FLEXIBLE SEAL FOR AN AIRCRAFT

(71) Applicant: Airbus Operations SAS, Toulouse (FR)

(72) Inventor: Thomas LUNN, BEAUZELLE (FR)

(21) Appl. No.: 15/899,082

(22) Filed: Feb. 19, 2018

(30) Foreign Application Priority Data
Feb. 22, 2017 (FR) 1751388

(51) Int. Cl. B60J 10/88; B64C 9/18; B60J 10/22; B64C 9/02

(52) U.S. Cl. CPC B60J 10/88; B64C 9/02; B60J 10/22; B64C 9/18

(57) ABSTRACT

A flexible seal intended to be fixed between a fixed part and a mobile part of an aircraft, the seal comprising an elongate hollow body, a shoe secured to the hollow body, intended to be fixed to the fixed part, a blade secured to the hollow body and designed to extend from the hollow body towards the mobile part, the blade having a leak edge having a non-linear edge, such as with notches or chevrons. The provision of a notched leak edge reduces a pressure differential on either side of the blade, and by allowing the air to pass between the blade and the fixed part just before the contact with the fixed part, the lifting of the blade is prevented.

### CROSS-REFERENCES TO RELATED APPLICATIONS

This application claims the benefit of the French patent application No. 1751388 filed on Feb. 22, 2017, the entire disclosures of which are incorporated herein by way of reference.

### TECHNICAL FIELD

The present invention relates to a flexible seal for an aircraft, comprising an elongate hollow body, a shoe and a blade, as well as an aircraft comprising at least one such seal.

### BACKGROUND OF THE INVENTION

An aircraft conventionally comprises at least one fixed wing on which are mounted flaps that are mobile between an extended position and a retracted position. In order to ensure the aerodynamic continuity between the wing and the flap in the retracted position, the wing has flexible seals which come to bear against the outer surface of the flap.

When the flap is in the extended position, the blade is no longer bearing, and because of the aerodynamic forces which are exerted on it upon the retraction of the flap, the blade can lift and be jammed between the wing and the flap. The blade is then deformed, which has an impact on the aerodynamics.

### SUMMARY OF THE INVENTION

One object of the present invention is to propose a seal in the form of a blade which is not jammed between the wing and the flap upon the retraction thereof.

To this end, a flexible seal is proposed which is intended to be fixed between a fixed part and a mobile part of an aircraft, the seal comprising:
an elongate hollow body,
a shoe secured to the hollow body and intended to be fixed to the fixed part,
a blade secured to the hollow body and designed to extend from the hollow body towards the mobile part, the blade having a leak edge having notches or chevrons.

The provision of a notched leak edge reduces the pressure differential on either side of the blade, and by allowing the air to pass between the blade and the fixed part before the contact of the leak edge with the fixed part, that eliminates the lifting of the blade. The invention further makes it possible to limit the wear of the seal and increase the life thereof.

Advantageously, the notches are distributed evenly along the leak edge.

Advantageously, the notches take the form of circular arc undulations.

Advantageously, the blade comprises an insert which extends over the length of the blade.

The invention also proposes an aircraft comprising a fixed part, a mobile part next to the fixed part and a seal according to one of the preceding variants, in which the shoe is fixed to the fixed part and in which the blade extends from the hollow body towards the mobile part.

Advantageously, the fixed part is a wing and the mobile part is a flap.

### BRIEF DESCRIPTION OF THE DRAWINGS

The features of the invention mentioned above, and others, will become more clearly apparent on reading the following description of an exemplary embodiment, said description being given in relation to the attached drawings, in which:

FIG. 1 is a plan view of an aircraft comprising a seal according to the invention,

FIG. 2 is a cross-sectional view according to the line II-II of FIG. 1 when the flap is in the extended position, and

FIG. 3 is a perspective view of a seal according to the invention.

### DETAILED DESCRIPTION OF THE PREFERRED EMBODIMENTS

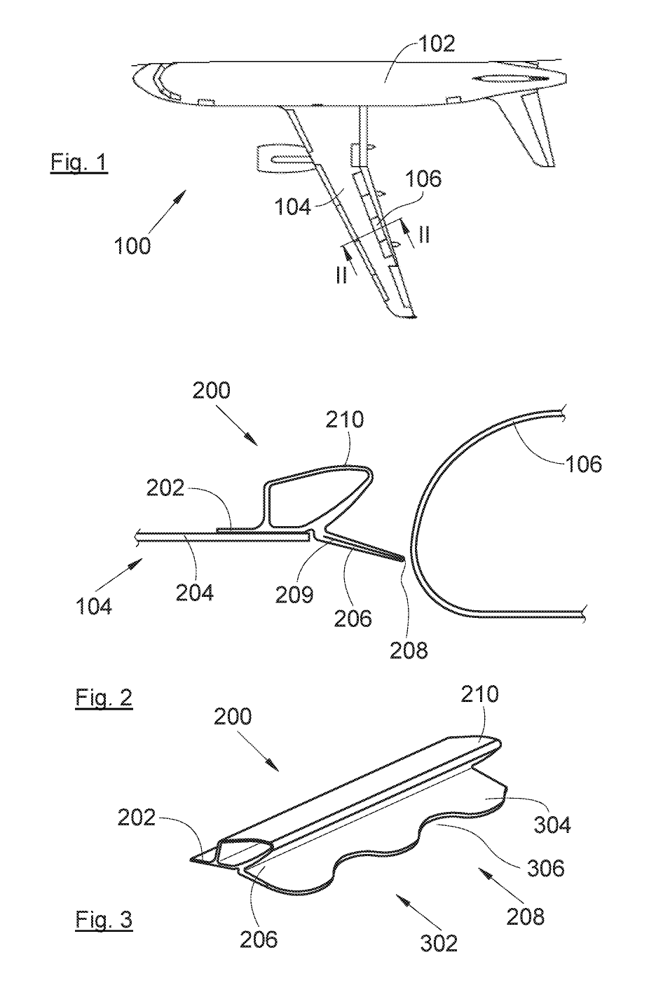

In the following description, the terms relating to a position are taken with reference to an aircraft in normal position of advance, which is to say, as is represented in FIG. 1.

FIG. 1 shows an aircraft 100 which comprises a fuselage 102, on either side of which is fixed a wing 104. The wing 104, which constitutes a fixed part, is fixed and bears flaps 106, each constituting a mobile part which is mobile between an extended position and a retracted position.

FIG. 2 shows a cross section of the aircraft 100 when the flap 106 is in an extended position relative to the wing 104, which is embodied here by a bottom panel 204 which forms the bottom part of the wing 104.

The aircraft 100 has a flexible seal 200 according to the invention. The seal 200 has a hollow body 210, a shoe 202 secured to the hollow body 210, and a blade 206 secured to the hollow body 210. The shoe 202 and the blade 206 are arranged on opposite sides of the hollow body 210.

In the embodiment of the invention presented here, the shoe 202 is fixed to the wing 104, which is to say, to the fixed part, and more particularly along the leak edge of the wing 104 and inside the bottom panel 204.

The blade 206 extends from the hollow body 210 towards the flap 106, which is to say, towards the mobile part, and the leak edge 208 of the blade 206 is therefore facing the flap 106.

The hollow body 210 is flexible, elongate, and extends along the leak edge of the wing 104. The flexibility of the hollow body 210 allows, among other things, the articulation of the blade 206.

When the flap 106 is in extended position, the leak edge 208 of the blade 206 is at a distance from the flap 106 and when the flap 106 is in retracted position, the leak edge 208 of the blade 206 comes to bear against the flap 106.

FIG. 3 is a perspective view of the seal 200.

The leak edge 208 of the blade 206 is not rectilinear, but has notches or chevrons 302 which form a succession of solid parts 304 and hollow parts 306. Thus, when the leak edge 208 approaches the flap 106, the leak edge 208 does not come into contact with the flap 106 over all of its length all at once.

In effect, in the approach of the flap 106, the solid parts 304 come first into contact with the flap 106, and the presence of the hollow parts 306 allows the passage of the air between the blade 206 and the flap 106. The notches 302 allow a reduction of the pressure differential on either side of the blade 206 just before the contact with the flap 106, which tends to eliminate the lifting of the blade 206. The blade 206 is then no longer jammed by the flap 106 which is displaced to its retracted position and the blade 206 comes to bear against the outer surface of the flap 106.

According to a variant of the invention, the notches or chevrons 302 are distributed evenly along the leak edge.

As specified above, the seal 200 is flexible to allow the blade 206 to press against the flap 106 when the latter is in a retracted position and ensure the seal. As a non-limiting example, the seal 200 can be made of silicone or of rubber.

According to a variant of the invention, the blade 206 can comprise an insert 209, for example of metal or of glass fiber. The insert 209 extends over the length of the blade 206 and makes it possible to strengthen the blade 206. The insert can, for example, be made of metal or of glass fiber.

In the embodiment of the invention presented in FIG. 3, the notches 302 take the form of circular arc undulations, but the notches can take another form such as, for example, sawteeth, or a succession of slits, or any other forms allowing a succession of solid and hollow parts.

The description of the invention above is more particularly applied to the flap of a wing, but it applies in the same way to the flap of tail plane unit or to any other seal which is fixed to a fixed part and which is designed to come to bear against a mobile part next to the fixed part.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A flexible seal intended to be fixed between a fixed part and a mobile part of an aircraft, the seal comprising:
an elongate hollow body,
a shoe secured to the hollow body and configured to be fixed to the fixed part,
a blade secured to the hollow body and configured to extend from the hollow body towards the mobile part, the blade having a non-linear leak edge.

2. The flexible seal according to claim 1, wherein the leak edge has notches or chevrons.

3. The flexible seal according to claim 2, wherein the notches are distributed evenly along the leak edge.

4. The flexible seal according to claim 2, wherein the notches take the form of circular arc undulations.

5. The flexible seal according to claim 1, wherein the blade comprises an insert which extends over a full length of the blade.

6. An aircraft comprising:
a fixed part,
a mobile part next to the fixed part, and
a seal according to claim 1,
the shoe being fixed to the fixed part and the blade extending from the hollow body towards the mobile part.

7. The aircraft according to claim 6, wherein the fixed part is a wing and wherein the mobile part is a flap.
